(19) United States
(12) Patent Application Publication
(10) Pub. No.: US 2011/0002699 A1
(43) Pub. Date: Jan. 6, 2011

(54) MEDIUM CONVEYANCE DEVICE, IMAGE FORMING DEVICE AND IMAGE FORMING SYSTEM

(75) Inventor: Hiroyuki Aoki, Ebina-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/790,414

(22) Filed: May 28, 2010

(30) Foreign Application Priority Data
Jul. 2, 2009 (JP) 2009-157903

(51) Int. Cl. G03G 15/00

(52) U.S. Cl. 399/17

(57) ABSTRACT

A medium conveyance device that conveys continuous paper in a paper continuation direction is provided. At a plurality of first image forming regions of the continuous paper, a plurality of corresponding images that correspond with a plurality of images, including a pre-established corresponding image, are formed with a spacing that corresponds to first size in the paper continuation direction, and at a plurality of second image forming regions of the continuous paper, a plurality of corresponding images that correspond with a plurality of images are formed with a spacing that corresponds to second size in the paper continuation direction. The corresponding images are detected on the basis of reading results of a reading interval corresponding to the first size. When the detected corresponding image is the pre-established corresponding image, the reading interval is changed to a reading interval corresponding to the second size.

### CROSS-REFERENCE TO RELATED APPLICATION

This application is based on and claims priority under 35 USC 119 from Japanese Patent Application No. 2009-157903 filed Jul. 2, 2009.

### BACKGROUND

1. Technical Field

The present invention relates to a medium conveyance device, an image forming device and an image forming system.

2. Related Art

A tandem printing system is known that includes a first printing device that forms an image at one face of a web, which does not have feed holes, and a second printing device that forms an image on a second face of the web, at least the first printing device including a mark formation component that forms a positioning mark at a pre-specified position of each page of the web, and at least the second printing device including a mark detection component that detects the positioning marks and a control component that matches up alignments of image positions to be formed at the second face of the web with image positions that have been formed at the first face, in accordance with the detection of the positioning marks.

A multiplex continuous printing device is also known, which is provided with a first printer that prints forms on the front face of a long strip of paper demarcated into page units while conveying the paper and a second printer that prints forms on a rear face of the paper, and thus prints forms on both sides of the paper while conveying the paper.

### SUMMARY

According to an aspect of the invention, there is provided a medium conveyance device that includes: a conveyance component that conveys continuous paper, in a paper continuation direction, on which a plurality of first image forming regions, whose lengths in the paper continuation direction are first size, are arrayed in the paper continuation direction and, subsequent to the plurality of first image forming regions, a plurality of second image forming regions, whose lengths in the paper continuation direction are second size that is different from the first size, are arrayed in the paper continuation direction, at the plurality of first image forming regions, a plurality of images are formed and a plurality of corresponding images that correspond with the plurality of images, including a pre-established corresponding image, are formed with a spacing in the paper continuation direction, and at the plurality of second image forming regions, a plurality of images are formed and a plurality of corresponding images that correspond with the plurality of images are formed with a spacing that corresponds to the second size in the paper continuation direction; a reading component that reads the continuous paper being conveyed by the conveyance component; a detection component that detects the corresponding images on the basis of reading results of the reading component at a reading interval corresponding to the first size; and a change component that, when the corresponding image detected by the detection component is the pre-established corresponding image, changes the reading interval of the detection component to a reading interval corresponding to the second size.

### BRIEF DESCRIPTION OF THE DRAWINGS

Exemplary embodiments of the present invention will be described in detail based on the following figures, wherein:

FIG. 1 is a schematic diagram illustrating structure of an image forming system relating to a first exemplary embodiment of the present invention;

FIG. 2 is a block diagram illustrating the structure of the image forming system relating to the first exemplary embodiment of the present invention;

FIG. 3 is a diagram showing an example of plural sheet IDs;

FIG. 4 is a diagram showing an example of plural sheet IDs;

FIG. 5 is a block diagram illustrating functional structure of a system controller of an upstream side system of the image forming system relating to the first exemplary embodiment of the present invention;

FIG. 6 is a conceptual diagram illustrating a state in which mark images are formed at continuous paper;

FIG. 7 is a block diagram illustrating functional structure of a system controller of a downstream side system of the image forming system relating to the first exemplary embodiment of the present invention;

FIG. 8 is a conceptual diagram illustrating a state in which a sheet ID corresponding to the timing of a change in a reading interval is detected and the reading interval is switched;

FIG. 9 is a flowchart illustrating details of a mark reading processing routine at an image forming device of the downstream side system of the image forming system relating to the first exemplary embodiment of the present invention;

FIG. 10 is a flowchart illustrating details of a second image forming processing routine at an image forming device of the downstream side system of the image forming system relating to the first exemplary embodiment of the present invention;

FIG. 11 is a diagram showing an example of plural sheet IDs;

FIG. 12 is a conceptual diagram illustrating a state in which a sheet ID corresponding to the timing of a change in a reading interval is detected and the reading interval is switched; and

FIG. 13 is a flowchart illustrating details of a second image forming processing routine at an image forming device of a downstream side system of an image forming system relating to a third exemplary embodiment of the present invention;

### DETAILED DESCRIPTION

Herebelow, exemplary embodiments of the present invention are described with reference to the attached drawings.

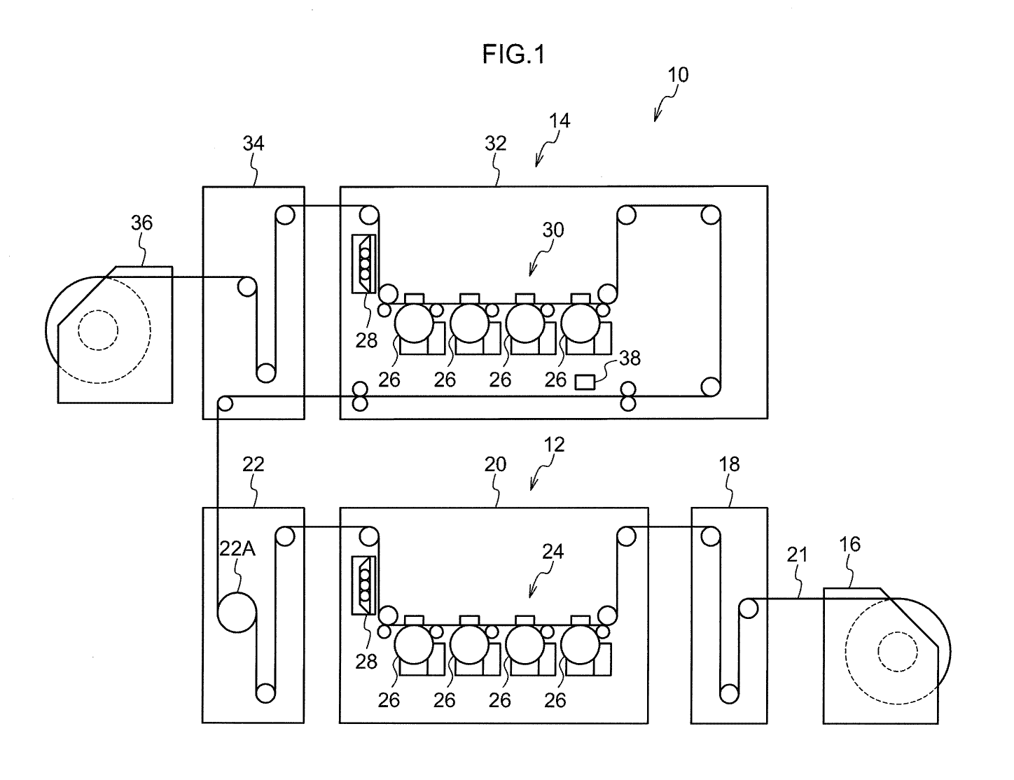

As illustrated in FIG. 1, an image forming system 10 relating to a first exemplary embodiment of the present invention is provided with an upstream side system 12 at an upstream side of a conveyance direction, and a downstream side system 14 at the conveyance direction downstream side.

The upstream side system 12 is provided with a pre-processing device 16, a buffer device 18, an image forming device 20 and an inversion device 22. Continuous paper 21 is paper that is loaded at the pre-processing device 16 and is continuous in one direction. The continuous paper 21 is supplied through the buffer device 18 to the image forming device 20, image forming is performed on one face (a first face) of the continuous paper 21 by the image forming device 20, and then the continuous paper 21 passes through the inversion device 22 and is inverted, and is conveyed to the downstream side system 14. The pre-processing device 16 performs various kinds of pre-processing before image formation is carried out on the continuous paper 21 (for example, punching, creation of perforation lines and the like). The inversion device 22 is provided with a turn bar mechanism 22A and switches between (flips) the first face and second face of the continuous paper 21. In the present exemplary embodiment, a case is described in which the upstream side system 12 and the downstream side system 14 use toners as materials for forming images and the images are formed on the continuous paper 21.

The buffer device 18 and the inversion device 22 are structured to accumulate the continuous paper 21 up to pre-established amounts. The buffer device 18 absorbs a difference between a processing speed of the pre-processing device 16 and a processing speed of the image forming device 20. The inversion device 22 absorbs a difference between the processing speed of the image forming device 20 and a processing speed of the downstream side system 14.

The image forming device 20 is provided with an image forming mechanism 24, and forms images on the continuous paper 21. The image forming mechanism 24 is structured to form images on the continuous paper 21 by an electrophotography system. Specifically, a charging device, an exposure device, a developing device, a transfer device, a cleaning device, a neutralizing device and suchlike are arranged in this order around each of photoreceptor drums 26 that correspond to cyan, magenta, yellow and black, and a fixing device 28 is disposed at the downstream side of the conveyance direction of the continuous paper.

That is, each photoreceptor drum 26 is rotated, the surface of the photoreceptor drum 26 is uniformly charged by the charging device, and a latent image is formed by the exposure device at the surface of the photoreceptor drum 26. Then the latent image formed at the surface of the photoreceptor drum 26 is developed by the developing device and a toner image is formed, and this toner image is transferred to the continuous paper 21 by the transfer device. The toner images that have been transferred to the continuous paper 21 are fixed by the 28. Toner that remains on the surface of the photoreceptor drum 26 instead of being transferred to the continuous paper 21 by the transfer device is removed by the cleaning device, and the surface of the photoreceptor drum 26 is de-electrified by the neutralizing device. Subsequently, the above-described processing, from charging by the charging device, is repeated, and thus images are formed. Herein, an image forming device that performs color image formation is illustrated in FIG. 1, but this is not to be limiting. An image forming device that is provided with one photoreceptor drum 26 and that carries out monochrome image forming may be used.

The downstream side system 14 at the conveyance direction downstream side is provided with an image forming device 32, a buffer device 34 and a post-processing device 36. The continuous paper 21 that is conveyed from the inversion device 22 passes through the buffer device 34 and is supplied to the image forming device 32. An image is formed on the other face (second face) of the continuous paper 21 by the image forming device 32, and then the continuous paper 21 passes through the buffer device 34 and is conveyed to the post-processing device 36. The post-processing device 36 rolls up the continuous paper 21 and performs various kinds of post-processing (for example, cutting to a predetermined size and bookbinding or the like) on the continuous paper 21 on both of whose faces images have been formed by the image forming device 20 and the image forming device 32.

The buffer device 34 is structured to accumulate the continuous paper 21 in a pre-established amount. The buffer device 34 absorbs a difference between a processing speed of the image forming device 32 and a processing speed of the post-processing device 36.

The image forming device 32 is provided with an image forming mechanism 30 similar to the image forming mechanism 24 of the image forming device 20, and forms images at the other face (the second face) of the continuous paper 21. Charging devices, exposure devices, developing devices, transfer devices, cleaning devices, neutralizing devices and suchlike are arranged in this order around the photoreceptor drums 26 that correspond to cyan, magenta, yellow and black in the image forming mechanism 30, and the fixing device 28 is disposed at the continuous paper conveyance direction downstream side thereof.

The image forming device 32 is provided with a mark reading device 38 on the conveyance path at the upstream side relative to the image forming mechanism 30. The mark reading device 38 is constituted with, for example, a spot-type optical sensor to one-dimensionally read marks that are formed as images on the first face of the continuous paper 21 that is being conveyed.

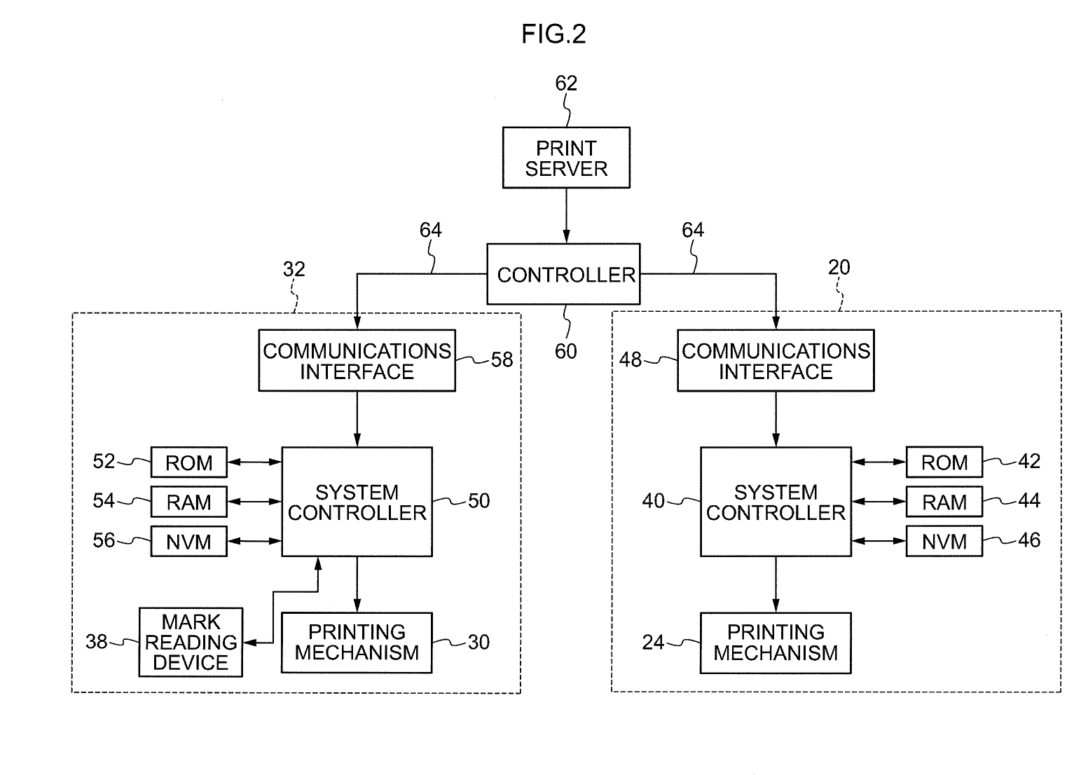

As illustrated in FIG. 2, the image forming device 20 of the upstream side system 12 is structured to include a system controller 40, read-only memory (ROM) 42, random access memory (RAM) 44, non-volatile memory (NVM) 46 and a communications interface 48. The ROM 42, the RAM 44, the NVM 46, the communications interface 48 and the image forming mechanism 24 are connected to the system controller 40.

The ROM 42 functions as a memory component in which image forming processing programs, various parameters, various data required for control, and the like are pre-memorized. The RAM 44 is used as a work area during execution of various programs, and the like. The NVM 46 memorizes various kinds of information that need to be retained if a power switch of the equipment is turned off.

The system controller 40 is constituted by a central processing unit (CPU) and peripheral circuits thereof and the like. The system controller 40 functions as a control device that controls the upstream side system 12 at the conveyance direction upstream side as a whole, in accordance with pre-established programs. The system controller 40 also functions as a computing device that performs various kinds of computing. That is, the system controller 40 controls operations of the image forming mechanism 24, controls reading and writing of the ROM 42, the RAM 44 and the NVM 46, and so forth.

The image forming device 32 of the downstream side system 14 is structured to include a system controller 50, read-only memory (ROM) 52, random access memory (RAM) 54, non-volatile memory (NVM) 56 and a communications interface 58. The ROM 52, the RAM 54, the NVM 56, the communications interface 58, the mark reading device 38 and the image forming mechanism 30 are connected to the system controller 50.

The ROM 52 functions as a memory component in which image forming processing programs, various parameters, various data required for control, and the like are pre-memorized. The RAM 54 is used as a work area during execution of various programs, and the like. The NVM 56 memorizes various kinds of information that need to be retained if the power switch of the equipment is turned off.

The system controller 50 is constituted by a central processing unit (CPU) and peripheral circuits thereof and the like. The system controller 50 functions as a control device that controls the downstream side system 14 as a whole, in accordance with pre-established programs. The system controller 50 also functions as a computing device that performs various kinds of computing. That is, the system controller 50 controls operations of the image forming mechanism 30, controls reading and writing of the ROM 52, the RAM 54 and the NVM 56, and so forth.

The image forming system 10 is further provided with a controller 60 and a print server 62 that outputs image formation instructions (print instructions) to the controller 60. The image forming devices 20 and 32 and the controller 60 are connected to a communications component 64 so as to exchange data and commands with one another. A structure is possible in which the print server 62 is included in the image forming system 10. The print server 62 is constituted by an ordinary server and the controller 60 is constituted by an ordinary personal computer.

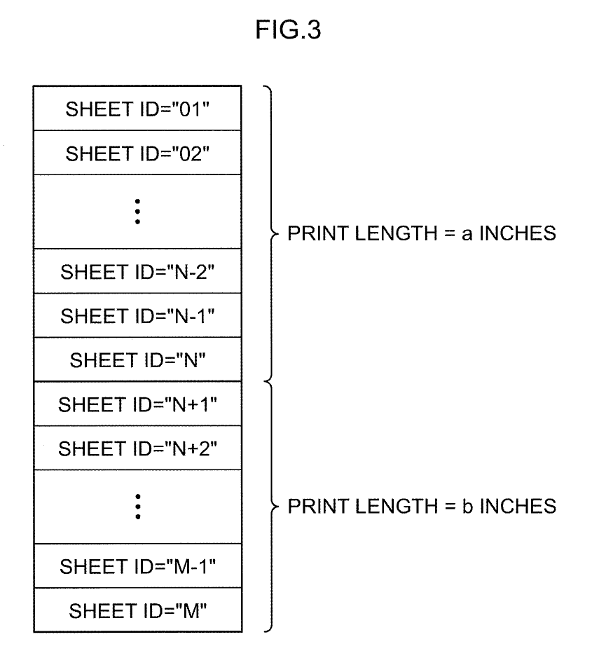

The print server 62 outputs duplex print data to the controller 60 as image forming instructions. Sheet IDs are included in the image forming instructions. The sheet IDs are appended to first face print data and second face print data that constitute the duplex print data and correspond to sheets. For example, as illustrated in FIG. 3, consecutive sheet IDs are included in image forming instructions outputted from the print server 62. The sheet IDs are information that identify sheets of the continuous paper 21 arranged in the paper continuation direction. The same sheet ID is appended to first face print data and second face print data that form images on the same sheet. Herein, the sheets of the continuous paper 21 that are arranged in the paper continuation direction represent image forming regions in accordance with a paper size. A print length of the print data corresponds with the size of the sheets in the paper continuation direction.

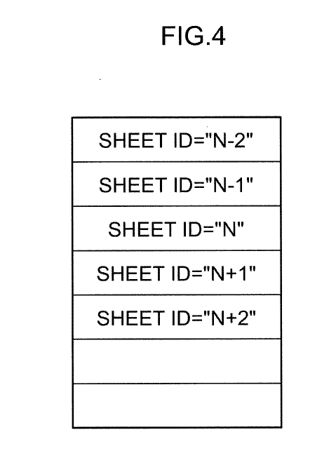

The controller 60 outputs, to the image forming device 20, image forming instructions that include plural sets of first face print data for forming images on the first face of the continuous paper 21 and consecutive plural sheet IDs as illustrated in FIG. 4. The controller 60 also outputs, to the image forming device 32, image forming instructions that include plural sets of second face print data for forming images on the second face of the continuous paper 21 and the plural sheet IDs. Further, the controller 60 outputs and registers the following to the image forming device 32: a sheet ID corresponding to a timing at which a reading interval changes, which is described below; a number of sheet ID detection cycles from the detection of the sheet ID that corresponds to the timing at which the reading interval is changed until the change in the reading interval is to be implemented; and a print length of the print data after the reading interval change (a length of the sheets in the paper continuation direction). The controller 60 also outputs and registers to the image forming device 32 a print length of initial print data and a position of formation of mark images.

Here, the sheet ID corresponding to the timing at which the reading interval changes and the print length of the print data after the reading interval change are set by the controller 60 on the basis of a switch in a print length included in the plural sets of print data and the print length after the switch. A number of cycles of detection of sheet IDs from a sheet ID that corresponds to a timing at which the reading interval changes until the change of the reading interval is implemented is pre-registered in the controller 60 based on the structure of the image forming device 32. The number of sheet ID detection cycles until a timing interval change is to be implemented is registered by the controller 60 on the basis of the registered information. In the present exemplary embodiment, a case in which the position of formation of mark images on the sheets is fixed regardless of paper sizes is described as an example.

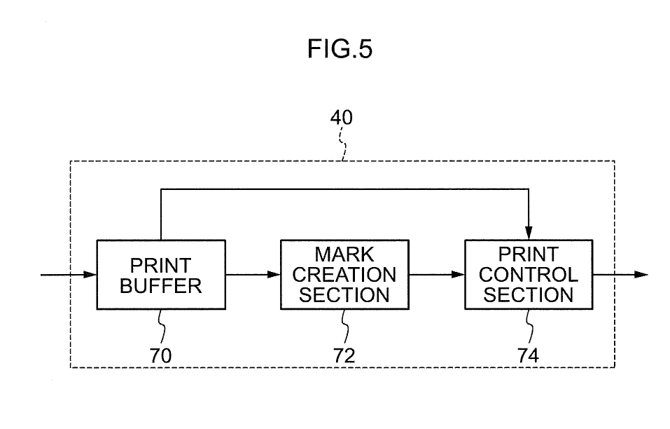

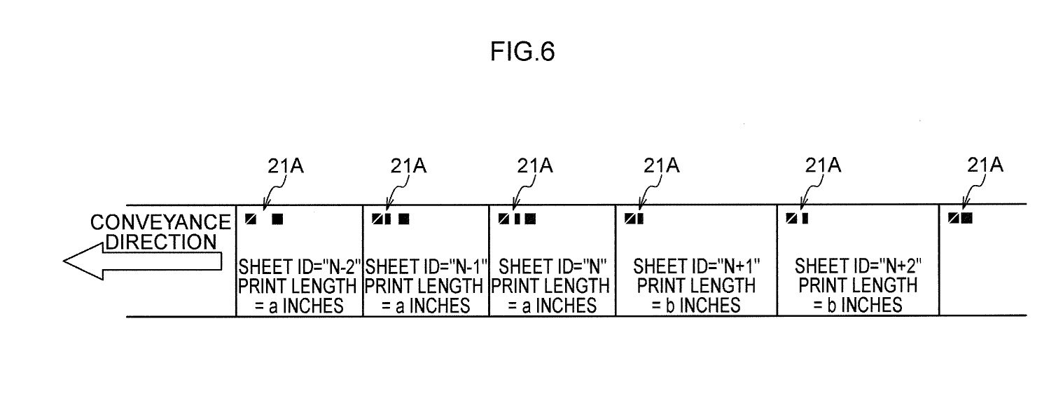

If the system controller 40 of the image forming device 20 is represented by functional blocks, as illustrated in FIG. 5, the system controller 40 is provided with a print buffer 70, a mark creation section 72 and a print control section 74. The print buffer 70 temporarily memorizes plural sets of print data and plural sheet IDs, illustrated in FIG. 4, which are inputted from the controller 60. The mark creation section 72 creates data of mark images that represent the sheet IDs. The print control section 74, on the basis of the first face print data and the mark image data, controls the image forming mechanism 24 so as to create images represented by the first face print data and images represented by the mark image data on the first face of the continuous paper 21. As illustrated in FIG. 6, mark images 21A representing the sheet IDs identifying each sheet (each image forming region) are formed on the corresponding sheets at an edge portion of the continuous paper 21. The mark images 21A are formed at a fixed position of each sheet regardless of the paper size of the sheets, and the mark images 21A are formed on the first face of the continuous paper 21 at an interval corresponding to the size of the sheets in the paper continuation direction.

The print buffer 70 temporarily memorizes the plural sets of first face image data and the plural sheet IDs inputted from the controller 60.

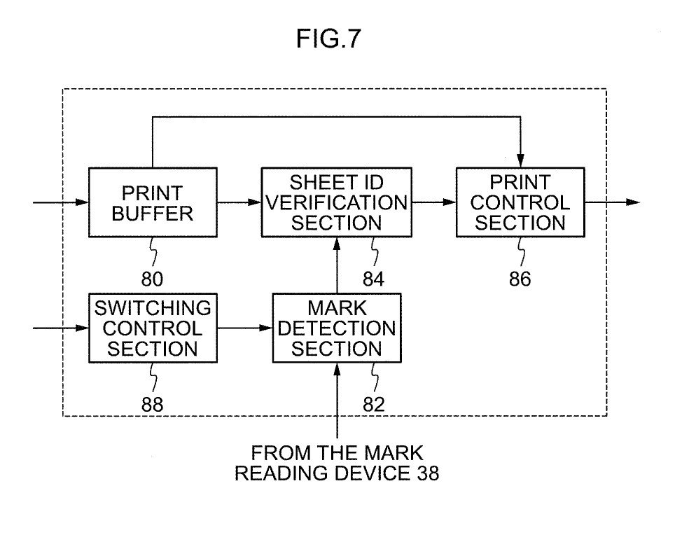

If the system controller 50 of the image forming device 32 is represented by functional blocks, as illustrated in FIG. 7, the system controller 50 is provided with a print buffer 80, a mark detection section 82, a sheet ID verification section 84, a print control section 86 and a switching control section 88.

The print buffer 80 temporarily memorizes plural sets of second face print data and the plural sheet IDs, illustrated in FIG. 4, which are inputted from the controller 60. The mark detection section 82 sets a reading interval on the basis of a specified initial print length of print data, and acquires mark reading signals read by the mark reading device 38 at timings based on the specified mark image formation position and the specified reading interval. The mark detection section 82 detects a sheet ID represented by a mark image 21A from the acquired reading data. For example, the sheet ID represented by the mark image 21A is detected by converting a mark reading signal represented by plural bits at 0/1 that is read from the mark image 21A to the sheet ID. Further, the mark detection section 82 sets a change of the reading timing on the basis of a print length of print data after the change, and then acquires mark reading signals read by the mark reading device 38 at timings based on the specified mark image formation position and the reading interval set at the change.

The sheet ID verification section 84 compares and verifies the sheet ID detected by the mark detection section 82 against a sheet ID corresponding to second face print data that is to be processed for image forming, which is a sheet ID inputted from the controller 60.

The print control section 86 controls the image forming mechanism 30 so as to form an image represented by second face print data at a sheet identified by a sheet ID at the second face of the continuous paper 21, on the basis of the second face image data that corresponds to the verified sheet ID. If the sheet ID is not verified, the print control section 86 stops image forming processing by the image forming mechanism 30.

The switching control section 88 memorizes a sheet ID corresponding to a timing at which the reading interval changes, a print length of the print data after the reading interval change, and the number of sheet ID detection cycles from detection of the sheet ID that corresponds to the timing at which the reading interval is changed until the change in the reading interval is to be implemented. The switching control section 88 compares sheet IDs detected by the mark detection section 82 with the sheet ID corresponding to the timing of the change. When a detected sheet ID matches the sheet ID corresponding to the change timing, the switching control section 88 waits for the number of sheet ID detection cycles until the reading interval change is to be implemented, and then switches and sets the reading interval at the mark detection section 82 on the basis of the memorized print length of the print data after the change (the size of the sheets in the paper continuation direction).

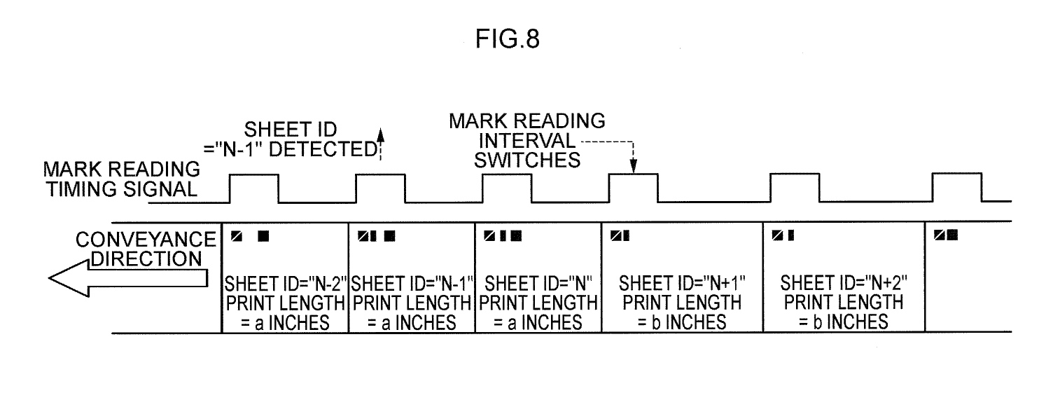

For example, as illustrated in FIG. 8, if the sheet ID corresponding to a change timing is “N−1”, then after the sheet ID “N−1” is detected, the reading interval is switched to a reading interval corresponding to a print length of b inches after, for example, two further sheet IDs have been detected.

Next, operations of the image forming system 10 relating to the first exemplary embodiment are described.

First, when the controller 60 receives image forming instructions from the print server 62, image formation control processing is executed at the CPU of the controller 60. Here, the image forming instructions include an image forming instruction that includes instructions to form images at both faces (the first face and the second face) of the continuous paper 21, and include first face print data and second face print data representing images to be formed on the continuous paper 21 and sheet IDs for identifying sheets at which the images based on the first face print data and the second face print data are to be formed.

The controller 60 inputs the first face print data representing images to be formed on the first face and sheet IDs that are included in the image forming instruction to the image forming device 20. The controller 60 also inputs the second face print data representing images to be formed on the second face and sheet IDs that are included in the image forming instruction to the image forming device 32.

Further, on the basis of the print lengths and sheet IDs included in the first face print data representing the images to be formed on the first face, the controller 60 outputs to the image forming device 32 a sheet ID of the first face print data two sheets prior to each sheet ID of the first face print data at which the print length is to be switched, as sheet IDs that correspond to timings at which the reading interval changes. The controller 60 also outputs to the image forming device 32 the print length (sheet size) of the first face print data subsequent to each switch and the number of cycles of sheet ID detection from when the sheet ID corresponding to the timing of a reading interval change is detected until the reading interval change is implemented, as information for setting the reading interval after each change.

Then, the controller 60 outputs to the image forming device 32 the initial print length of the first face print data and the position of formation of the mark images 21A, as initial settings information.

The system controller 40 of the image forming device 20 creates data of mark images that represent the inputted sheet IDs, and controls the image forming mechanism 24 so as to form images based on the first face print data and the mark images 21A on the first face. Thus, images based on the first face print data and the mark images 21A representing the sheet IDs are consecutively formed.

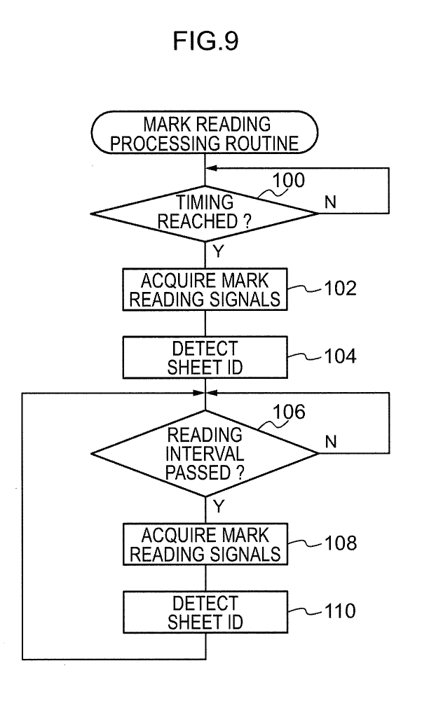

At the system controller 50 of the image forming device 32, when the second face print data, the sheet IDs, the sheet ID corresponding to each timing at which the reading interval changes, the print length of the print data after each change, and the initial settings information are inputted, the same are stored in the RAM 54. Then the system controller 50 executes the mark reading processing routine illustrated in FIG. 9.

Firstly, in step 100, the processing determines whether or not a timing for reading the mark images 21A that is set on the basis of the initial settings information has been reached. When the reading timing set on the basis of the initial settings information is reached, control passes to step 102, and mark reading signals are acquired from the mark reading device 38 for a pre-specified duration corresponding with a width of each mark image 21A. Then, in step 104, the sheet ID represented by the mark image 21A is detected from the mark reading signals acquired in step 102.

In step 106, it is determined whether or not the reading interval set on the basis of the initial settings information, or a reading interval that has been changed in step 140 which is described below, has passed since the previous reading. When the reading interval has passed, in step 108, mark reading signals are acquired from the mark reading device 38 for the pre-specified duration corresponding with the width of the mark images 21A. Then, in step 110, the sheet ID represented by the mark image 21A is detected from the mark reading signals acquired in step 102.

By the mark reading processing routine being executed as described above, as illustrated in FIG. 8, the mark images 21A formed on the first face of the continuous paper 21 are consecutively read, and the sheet IDs represented by the mark images 21A are consecutively detected.

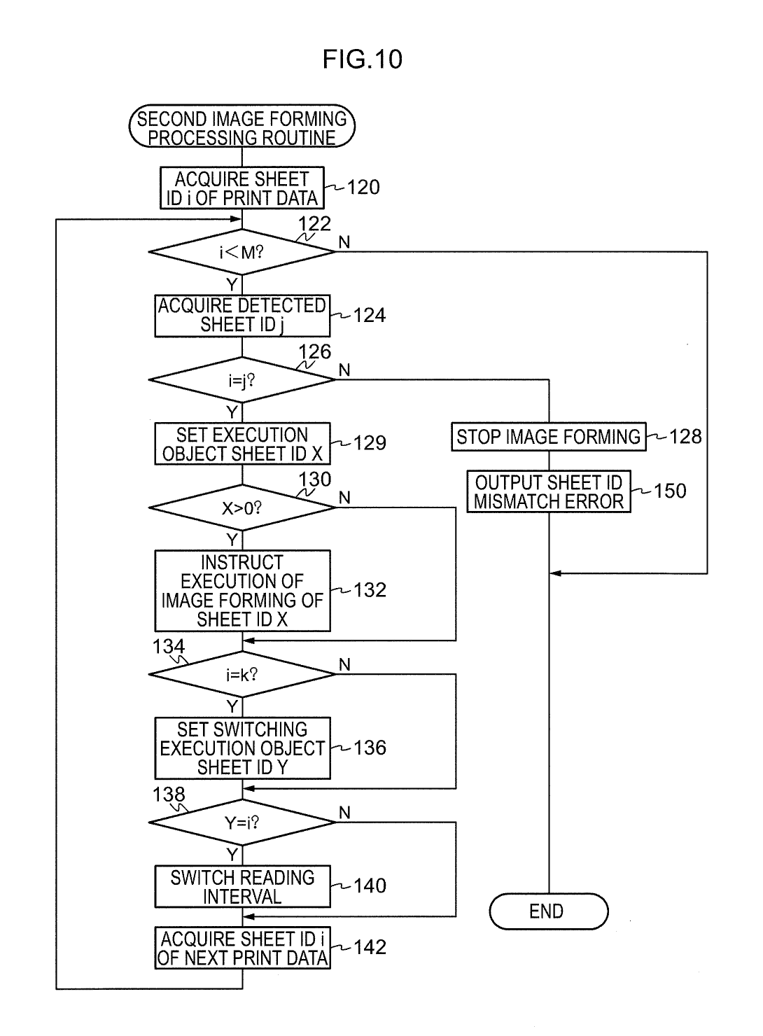

The system controller 50 of the image forming device 32 also executes the second face image forming processing routine illustrated in FIG. 10. This is executed in parallel with the above-described mark reading processing routine.

First, in step 120, a value of a variable i representing sheet IDs that corresponds to the initial second face print data is acquired from the RAM 54. Then, in step 122, it is determined whether or not the variable i representing the sheet ID is smaller than a variable M that represents a sheet ID corresponding to the end of the image forming processing. When the variable i representing sheet IDs reaches the variable M, the second image formation processing routine ends, which is the end of the image forming processing. On the other hand, while the variable i representing sheet IDs corresponding with the second face print data is smaller than the variable M, in step 124, a variable j that represents a sheet ID detected by the above-described mark reading processing routine is acquired.

Next, in step 126, it is determined whether or not the variable i representing sheet IDs corresponding to the second face print data matches the variable j representing the detected sheet ID. If the variable i does not match with the variable j, then in step 128 image forming processing by the image forming mechanism 30 stops, an error message indicating a sheet ID mismatch error is outputted to the controller 60, and the second image forming processing routine ends.

On the other hand, when there is a match in step 126, control passes to step 129, and sets a variable X that represents a sheet ID corresponding to the second face print data that is to be the object of execution of the image forming processing. Positions of the mark reading device 38 and the image forming mechanism 30 are offset along the conveyance path of the continuous paper 21. For example, a currently detected sheet ID and the sheet ID corresponding to the second face print data that is the current object of execution of the image forming processing are offset by an amount corresponding to n sheets. Accordingly, a value for which n is subtracted from the variable i is set as the variable X.

Then, in step 130, it is determined whether or not the variable X is greater than zero. If the variable X is zero or less, the timing of execution of the image forming processing based on the initial second face print data has not been reached, and control passes to step 134. On the other hand, if the variable X is greater than zero in step 130, then in step 132 the image forming mechanism 30 is instructed to execute image forming processing on the basis of the second face print data corresponding to the sheet ID that is the variable X. As a result, at the image forming mechanism 30, an image based on the second face print data that corresponds to the sheet ID that is the variable X is formed on the sheet of the second face of the continuous paper 21 that is identified by the sheet ID that is the variable X.

In step 134, it is determined whether or not the variable i representing the sheet ID corresponding to the second face print data (=variable j) matches a variable k that represents a sheet ID corresponding to the timing at which the reading interval is to change, which is memorized in the RAM 54. If the variable i and the variable k do not match, control passes to step 138.

On the other hand, when the variable i and the variable k match in step 134, then in step 136 a variable Y representing the sheet ID that is to be the object of switching execution is set. Because the switching execution object sheet ID has been set beforehand, as described above, the sheet ID m sheets before the switching execution object sheet ID has been registered as the sheet ID corresponding to the timing at which the reading interval changes. In step 136, for example, a value for which m is added to the variable i is set as the variable Y.

If a plural number of sheet IDs corresponding to timings at which the reading interval changes have been memorized, then when at least one sheet ID is matched, m is added to the variable representing the matching sheet ID to set the variable Y.

In step 138, it is determined whether or not the variable Y matches the variable i. When these do not match, control passes to step 142. On the other hand, when the variable Y matches the variable i, then in step 140 the timing interval is switched to the timing interval after the change, on the basis of the print length of the print data after the change that has been memorized in the RAM 54.

In step 142, the sheet ID corresponding to the next sheet of the second print face data is acquired and stored in the variable i, and control returns to the aforementioned step 122.

By the second face image forming processing routine being executed as described above, images are consecutively formed at the second face of the continuous paper 21, and reading intervals of the mark images 21A are changed at specified timings.

Next, a second exemplary embodiment is described. Herein, because structure of an image forming system relating to the second exemplary embodiment is the same structure as in the first exemplary embodiment, the same reference numerals are assigned and descriptions concerning structures are not given.

The second exemplary embodiment differs from the first exemplary embodiment in that the sheet IDs are numerical values in a pre-established range and a sheet ID that corresponds to a timing at which the reading interval changes is a numerical value outside the pre-established range.

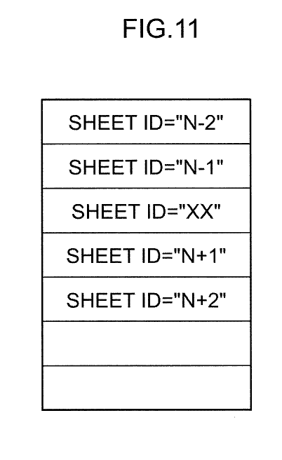

In the second exemplary embodiment, a plural number of sheet IDs are included in the image forming instructions outputted from the print server 62. For example, as illustrated in FIG. 11, a sheet ID outside a pre-established range (for example, a range from 1 to 1000) is inserted into consecutive sheet IDs within the pre-established range. The controller 60 outputs an image forming instruction including plural sets of first face print data for forming images on the first face of the continuous paper 21 and the plural sheet IDs shown in FIG. 11 to the image forming device 20. The controller 60 outputs an image forming instruction including plural sets of second face print data for forming images on the second face of the continuous paper 21 and the plural sheet IDs shown in FIG. 11 to the image forming device 32. The controller 60 also outputs to the image forming device 32 each sheet ID outside the pre-established range that corresponds to a timing at which the reading interval is to change, a print length of the first face print data after the reading interval change, and a number of sheet ID detection cycles until the change in the reading interval is implemented.

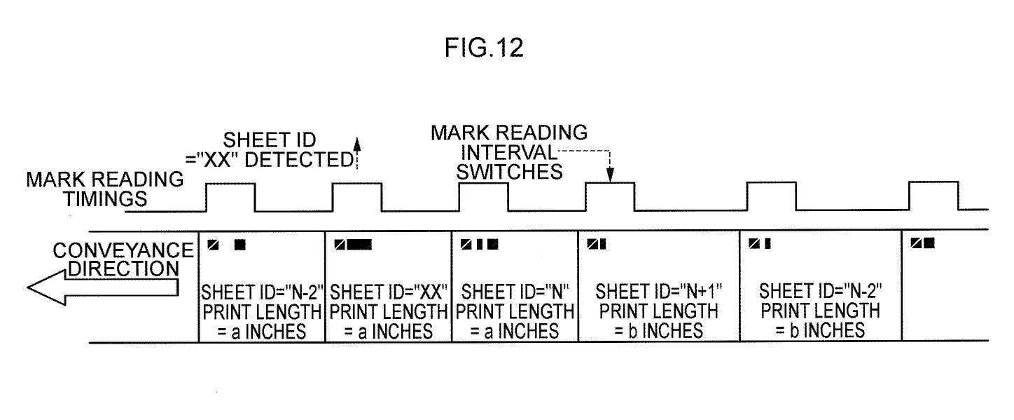

At the system controller 40 of the image forming device 20, the plural sets of first face print data and the above-mentioned plural sheet IDs shown in FIG. 11, which are inputted from the controller 60, are temporarily memorized in the print buffer 70. The mark creation section 72 generates mark image data representing the sheet IDs. The print control section 74 controls the image forming mechanism 24 on the basis of the first face print data and the mark image data so as to form the images represented by the first face print data and the images represented by the mark image data on the first face of the continuous paper 21. As illustrated in FIG. 12, the mark images 21A representing the sheet IDs are formed on the respective sheets at the edge portion of the continuous paper 21.

At the system controller 50 of the image forming device 32, the plural sets of print data and plural sheet IDs shown in FIG. 11, which are inputted from the controller 60, are temporarily memorized in the print buffer 80. The mark detection section 82 acquires reading data read by the mark reading device 38 at the specified reading interval, and detects the sheet IDs represented by the mark images 21A from the acquired reading data.

The sheet ID verification section 84 compares and verifies a sheet ID detected by the mark detection section 82 against a sheet ID corresponding to second face print data that is to be processed for image forming, which is a sheet ID inputted from the controller 60.

The print control section 86 controls the image forming mechanism 30 so as to form an image represented by the second face print data at a sheet of the second face of the continuous paper 21 that is identified by a sheet ID, on the basis of the second face print data that corresponds with the verified sheet ID. If a sheet ID is not verified, the print control section 86 stops image forming processing by the image forming mechanism 30.

The switching control section 88 memorizes each sheet ID outside the pre-established range, which corresponds to a timing at which the reading interval is to change, a print length of the print data after the reading interval change, and the number of sheet ID detection cycles until the change in the reading interval is implemented, which have been inputted from the controller 60. In addition, the switching control section 88 compares sheet IDs detected by the mark detection section 82 with the sheet ID corresponding to each change timing. When a detected sheet ID matches the sheet ID corresponding to the change timing, as illustrated in FIG. 12, the switching control section 88 switches to a reading interval corresponding to a print length of b inches after, for example, a second sheet ID is detected after the sheet ID “XX” corresponding to the change timing has been detected.

Herein, other structures and operations of the image forming system relating to the second exemplary embodiment are the same as in the first exemplary embodiment, so will not be described.

Next, a third exemplary embodiment is described. Here, because structure of an image forming system relating to the third exemplary embodiment is the same structure as in the first exemplary embodiment, the same reference numerals are assigned and descriptions concerning structures are not given.

The third exemplary embodiment differs from the first exemplary embodiment in that, if a detected sheet ID does not conform to a rule of the sheet IDs, it is supplemented with a sheet ID that follows the rule.

In the third exemplary embodiment, a plural number of sheet IDs are included in the image forming instructions outputted from the print server 62. For example, as illustrated in the aforementioned FIG. 11, sheet IDs change in accordance with a pre-established rule of incrementing in intervals of +1, and a sheet ID that does not follow the rule is inserted therein. The controller 60 outputs an image forming instruction including plural sets of first face print data for forming images on the first face of the continuous paper 21 and the plural sheet IDs shown in FIG. 11 to the image forming device 20. The controller 60 outputs an image forming instruction including plural sets of second face print data for forming images on the second face of the continuous paper 21 and the plural sheet IDs shown in FIG. 11 to the image forming device 32. The controller 60 also outputs to the image forming device 32 a sheet ID that does not follow the rule to correspond to each timing at which the reading interval is to change, the number of cycles of sheet ID detection from when the sheet ID corresponding to a timing of the reading interval change is detected until the reading interval change is implemented, and a print length of the print data after the change.

At the system controller 40 of the image forming device 20, the plural sets of first face print data and the above-mentioned plural sheet IDs shown in FIG. 11, which are inputted from the controller 60, are temporarily memorized in the print buffer 70. The mark creation section 72 generates mark image data representing the sheet IDs. The print control section 74 controls the image forming mechanism 24 on the basis of the print data and the mark image data so as to form the images represented by the first face print data and the images represented by the mark image data on the first face of the continuous paper 21.

At the system controller 50 of the image forming device 32, the plural sets of second face print data and plural sheet IDs shown in FIG. 11, which are inputted from the controller 60, are temporarily memorized in the print buffer 80. The mark detection section 82 acquires reading data read by the mark reading device 38 at the specified reading interval, and detects the sheet IDs represented by the mark images 21A from the acquired reading data.

The sheet ID verification section 84 compares and verifies the sheet IDs detected by the mark detection section 82 against sheet IDs that follow the pre-established rule.

The print control section 86 controls the image forming mechanism 30 so as to form an image represented by print data at a sheet of the second face of the continuous paper 21 that is identified by a sheet ID, on the basis of the second face print data that corresponds to the verified sheet ID. If a sheet ID is not verified, the print control section 86 counts a number of verification failures, and if the counted number of verification failures is less than a prescribed number of verification failures specified in advance, supplements the sheet ID in accordance with the rule and controls the image forming mechanism 30 so as to form an image represented by the second face print data on the sheet of the second face of the continuous paper 21 that is identified by the sheet ID, on the basis of the second face print data that corresponds to the supplemented sheet ID. If a sheet ID is not verified and the counted number of verification failures is at or above the prescribed number of verification failures, the print control section 86 stops image forming processing by the image forming mechanism 30.

The switching control section 88 memorizes each sheet ID that does not follow the pre-established rule, which corresponds to a timing at which the reading interval is to change, the number of sheet ID detection cycles until the change in the reading interval is implemented and information representing a reading interval after the change, which have been inputted from the controller 60. In addition, the switching control section 88 compares sheet IDs detected by the mark detection section 82 with the sheet ID corresponding to the change timing. When a detected sheet ID matches the sheet ID corresponding to the change timing, as illustrated in FIG. 12, the switching control section 88 switches the reading interval to a reading interval corresponding to a print length of b inches after, for example, a second sheet ID is detected after the sheet ID “XX” corresponding to the change timing has been detected.

The system controller 50 of the image forming device 32 relating to the third exemplary embodiment executes a mark reading processing routine the same as in the above-described first exemplary embodiment.

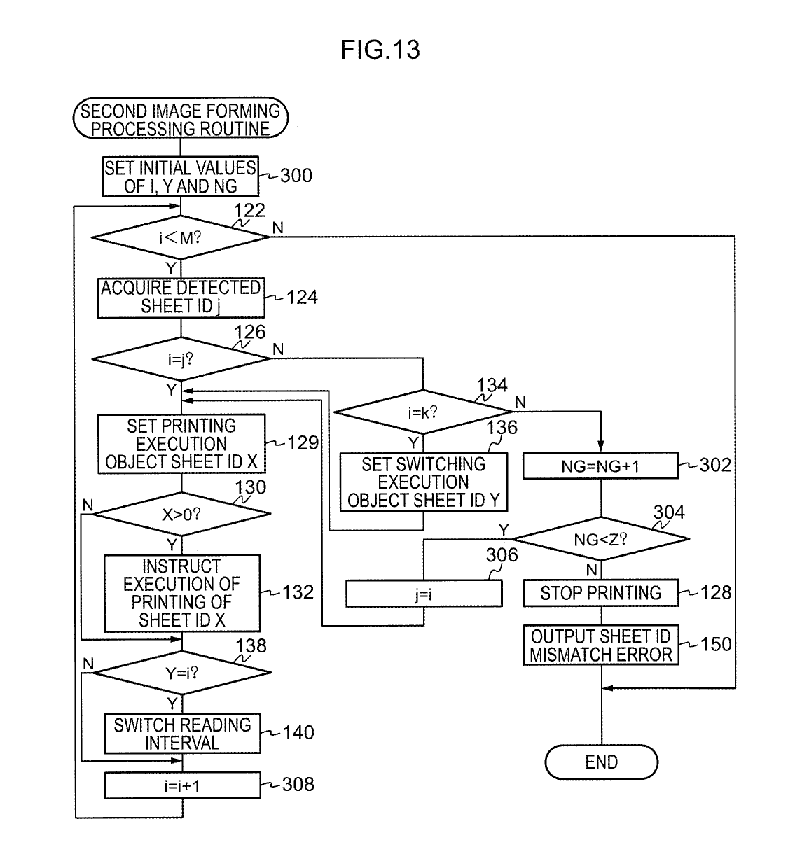

Next, a second image forming processing routine by the system controller 50 of the image forming device 32 relating to the third exemplary embodiment is described using FIG. 13. This is executed in parallel with the above-described mark reading processing routine. Processing the same as in the first exemplary embodiment is assigned the same reference numerals and is not described in detail.

First, in step 300, the variable i representing sheet IDs corresponding with the second face print data is set to an initial value of 1. The variable Y representing switching execution object sheet IDs and a number of verification failures NG are both set to initial values of 0.

Then, in step 122, it is determined whether or not the variable i representing sheet IDs is smaller than the variable M that represents a sheet ID corresponding to the end of the image forming processing. When the variable i representing sheet IDs reaches the variable M, the second image formation processing routine ends, which is the end of the image forming processing. On the other hand, while the variable i representing sheet IDs corresponding with the second face print data is smaller than the variable M, in step 124, the variable j that represents a sheet ID detected by the above-described mark reading processing routine is acquired.

Next, in step 126, it is determined whether or not the variable i representing sheet IDs corresponding to the second face print data matches the variable j representing the detected sheet ID. If the variable i does not match with the variable j, then in step 134 it is determined whether or not the variable i representing the sheet ID corresponding to the second face print data (=variable j) matches the variable k that represents a sheet ID corresponding to the timing at which the reading interval is to change, which is memorized in the RAM 54. If the variable i and the variable k match, then in step 136 the variable Y representing a switching execution object sheet ID is set. For example, a value for which m is added to the variable i is set as the variable Y.

If the variable i does not match with the variable k in step 134, control passes to step 302, and the number of verification failures NG is incremented by +1 to count the number of verification failures. Then, in step 304, it is determined whether or not the counted number of verification failures NG is less than a prescribed number of verification failures Z that is specified beforehand. If the counted number of verification failures NG is at or above the prescribed number of verification failures Z, then in step 128 the image forming processing by the image forming mechanism 30 stops, in step 150 an error message indicating a sheet ID mismatch error is outputted to the controller 60, and the second image forming processing routine ends.

On the other hand, when the counted number of verification failures NG is less than the prescribed number of verification failures Z in step 304, then, in step 306, the variable j representing the detected sheet ID corresponding to the first face print data is changed to the value of the variable i which follows the rule, the sheet ID is supplemented in accordance with the rule, and control passes to step 129.

When the variable j representing a detected sheet ID corresponding to the first face print data and the variable i following the rule match in step 126, control passes to step 129.

In step 129, the variable X representing a sheet ID corresponding to the second face print data that is to be the object of execution of the image forming processing is set. For example, a value for which n is subtracted from the variable i is set as the variable X.

Then, in step 130, it is determined whether or not the variable X is greater than zero. If the variable X is zero or less, the timing of execution of the image forming processing based on the initial second face print data has not been reached, and control passes to step 138. On the other hand, if the variable X is greater than zero in step 130, then in step 132 the image forming mechanism 30 is instructed to execute image forming processing on the basis of the second face print data corresponding to the sheet ID that is the variable X. As a result, at the image forming mechanism 30, an image based on the second face print data that corresponds to the sheet ID that is the variable X is formed on the sheet of the second face of the continuous paper 21 that is identified by the sheet ID that is the variable X.

In step 138, it is determined whether or not the variable Y matches the variable i. When these do not match, control passes to step 308. On the other hand, when the variable Y matches the variable i, then in step 140 the timing interval is switched to the timing interval after the change, on the basis of the print length of the print data after the reading interval change that is memorized in the RAM 54.

In step 308, the variable i representing sheet IDs corresponding to the print data is incremented by +1 in accordance with the rule, and control returns to step 122.

By the second face image forming processing routine being executed as described above, images are consecutively formed at the second face of the continuous paper 21, reading intervals of the mark images 21A are changed at specified timings, and the mark images 21A are read.

Here, for the third exemplary embodiment described above, a case in which sheet IDs that do not follow a rule are specified to be sheet IDs corresponding to timings of changes of the reading interval has been described as an example, but this is not to be limiting. Sheet IDs that follow the rule may be set as being sheet IDs that correspond to timings of changes of the reading interval.

In the first exemplary embodiment to third exemplary embodiment described above, cases of forming mark images that represent sheet IDs identifying sheets on the continuous paper have been described as an example, but this is not to be limiting. Mark images that represent other kinds of information may be formed. For example, mark images that represent that a sheet corresponds to a switching timing may be formed on the continuous paper. Further, mark images that represent sheet IDs and print lengths of print data may be formed on the continuous paper. For example, a mark image may be constituted so as to represent a print length of print data after a change of reading interval. Further still, mark images that represent print data corresponding to the timings of changes of the reading interval as well as sheet IDs may be formed on the continuous paper.

Furthermore, a case has been described as an example in which, after a sheet ID corresponding to a reading interval change timing is detected, the processing waits for the detection of a certain number of sheet IDs and then implements the reading interval change, but this is not to be limiting. A reading interval change may be implemented immediately after the sheet ID corresponding to the reading interval change timing is detected. Further, how long after the detection of a sheet ID corresponding to a reading interval change timing the reading interval change is to be implemented may be varied in accordance with settings.

A case in which the mark reading device is constituted with a spot-type optical sensor has been described as an example, but this is not to be limiting. The mark reading device may be structured with a line-type optical sensor. In such a case, the mark images may be read two-dimensionally, and various kinds of information may be detected, including sheet IDs represented by the two-dimensional mark images.

A case in which positions of formation of the mark images are fixed on the sheets has been described as an example, but this is not to be limiting. Positions of formation of the mark images may be varied. For example, if the position of formation of the mark images is changed when the paper size of the sheet is switched, it is sufficient for the mark reading signals to be acquired at timings with reading intervals that correspond to print lengths of the print data and to positions of formation of the mark images.

A case in which image formation on the two faces is performed by the upstream side system and the downstream side system has been described as an example, but this is not to be limiting. An image forming system in which superposed images are formed on the same face by an upstream side system and a downstream side system is also possible. In such a case, the upstream side system forms an image and a mark image on a sheet of one face, and the downstream side system may form on the same face, superposed with the image, an image based on data that corresponds with the sheet ID of that sheet.

A case has been described as an example in which it is the controller that sets the sheet ID corresponding to each reading interval change timing, the number of cycles of sheet ID detection from the detection of that sheet ID until the reading interval change is to be implemented and the like, but this is not to be limiting. The sheet ID corresponding to each reading interval change timing, the number of cycles of sheet ID detection from the detection of that sheet ID until the reading interval change is implemented and the like may be set by input operations by an operator.

A case in which an image forming device forms images on continuous paper using toners as materials for forming images has been described, but this is not to be limiting. An image forming device may form images on continuous paper using inks as materials for forming images. Furthermore, materials for forming these images are not to be limited to toners and inks, and may be other materials.

A case has been described as an example in which a mark detection section acquires mark reading signals that are read by a mark reading device at a reading interval and detects sheet IDs represented by the mark images, but this is not to be limiting. A mark reading device may read the continuous paper at a specified reading interval and output the mark reading signals.

What is claimed is:

1. A medium conveyance device comprising:
a conveyance component that conveys continuous paper, in a paper continuation direction, on which
a plurality of first image forming regions, whose lengths in the paper continuation direction are first size, are arrayed in the paper continuation direction and, subsequent to the plurality of first image forming regions, a plurality of second image forming regions, whose lengths in the paper continuation direction are second size that is different from the first size, are arrayed in the paper continuation direction,
at the plurality of first image forming regions, a plurality of images are formed and a plurality of corresponding images that correspond with the plurality of images, including a pre-established corresponding image, are formed with a spacing in the paper continuation direction, and
at the plurality of second image forming regions, a plurality of images are formed and a plurality of corresponding images that correspond with the plurality of images are formed with a spacing that corresponds to the second size in the paper continuation direction;
a reading component that reads the continuous paper being conveyed by the conveyance component;
a detection component that detects the corresponding images on the basis of reading results of the reading component at a reading interval corresponding to the first size; and
a change component that, when the corresponding image detected by the detection component is the pre-established corresponding image, changes the reading interval of the detection component to a reading interval corresponding to the second size.

2. An image forming device comprising:
a conveyance component that conveys continuous paper in a paper continuation direction, on which
a plurality of first image forming regions, whose lengths in the paper continuation direction are first size, are arrayed in the paper continuation direction and, subsequent to the plurality of first image forming regions, a plurality of second image forming regions, whose lengths in the paper continuation direction are second size that is different from the first size, are arrayed in the paper continuation direction,
at the plurality of first image forming regions, a plurality of images are formed and a plurality of identification images that represent a plurality of sets of identification information that identify the plurality of first image forming regions, including a pre-established set of identification information, are formed with a spacing that corresponds to the first size in the paper continuation direction, and
at the plurality of second image forming regions, a plurality of images are formed and a plurality of identification images that represent a plurality of sets of identification information that identify the plurality of second image forming regions are formed with a spacing that corresponds to the second size in the paper continuation direction;
a reading component that reads the continuous paper being conveyed by the conveyance component;
a detection component that detects the identification images on the basis of reading results of the reading component at a reading interval corresponding to the first size;
a change component that, when the identification information that is represented by the identification image detected by the detection component is the pre-established identification information, changes the reading interval of the detection component to a reading interval corresponding to the second size; and
an image forming component that, on the basis of image information that is inputted in correspondence with the identification information detected by the detection component, uses a material for forming images to form an image in a first image forming region or a second image forming region that is identified by the identification information of the continuous paper being conveyed by the conveyance component.

3. The image forming device of claim 2, wherein the image forming component forms the image on a face at the opposite side of the continuous paper being conveyed by the conveyance component from a face thereof at which the images and the identification images are formed.

4. The image forming device of claim 2, further comprising a verification component that verifies the identification information detected by the detection component against the identification information corresponding with the inputted image information,
wherein the image forming component stops formation of images if the identification information is not verified by the verification component.

5. The image forming device of claim 2, wherein
the identification information changes by a pre-established rule between each of the first image forming regions and second image forming regions of the continuous paper,
the image forming device further comprises a verification component that verifies the identification information detected by the detection component against the identification information changing by the rule, and,
if the identification information is not verified by the verification component, the image forming component forms an image on the continuous paper being conveyed by the conveyance component on the basis of image information inputted in correspondence with identification information that changes by the rule.

6. The image forming device of claim 5, wherein the image forming component stops formation of images if a number of cases in which the identification information is not verified reaches at least a pre-specified number.

7. An image forming system comprising:
an inversion component that inverts between faces of continuous paper that is being conveyed;
a first conveyance component that conveys the continuous paper in a paper continuation direction, on which a plurality of first image forming regions, whose lengths in the paper continuation direction are first size, are arrayed in the paper continuation direction and, subsequent to the plurality of first image forming regions, a plurality of second image forming regions, whose lengths in the paper continuation direction are second size that is different from the first size, are arrayed in the paper continuation direction;
an upstream side image forming device including a first image forming component that, on the basis of each of a plurality of inputted sets of image information, uses a material for forming images to form, on one face of the continuous paper being conveyed by the first conveyance component,
a plurality of images in the plurality of first image forming regions,
a plurality of identification images that represent a plurality of sets of identification information that identify the plurality of first image forming regions, including a pre-established set of identification information, with a spacing that corresponds to the first size in the paper continuation direction,
a plurality of images in the plurality of second image forming regions, and
a plurality of identification images that represent a plurality of sets of identification information that identify the plurality of second image forming regions, with a spacing that corresponds to the second size in the paper continuation direction,
the upstream side image forming device being disposed at a conveyance direction upstream side of the inversion component;
a second conveyance component that conveys the continuous paper on which the images and the identification images have been formed by the upstream side image forming device and that has been inverted by the inversion component in the paper continuation direction;
a reading component that reads the continuous paper being conveyed by the second conveyance component;
a detection component that detects the identification images on the basis of reading results of the reading component at a reading interval corresponding to the first size;
a change component that, when the identification information that is represented by the identification image detected by the detection component is the pre-established identification information, changes the reading interval of the detection component to a reading interval corresponding to the second size; and
a downstream side image forming device including a second image forming component that, on the basis of input image information corresponding with the identification information represented by an identification image detected by the detection component, uses a material for forming images to form an image in a first image forming region or a second image forming region identified by the identification information, on the face at the opposite side of the continuous paper being conveyed by the second conveyance component from the face thereof at which the images and the identification images are formed, the downstream side image forming device being disposed at the conveyance direction downstream side of the inversion component.
